(19) United States
(12) Patent Application Publication
(10) Pub. No.: US 2015/0310727 A1
(43) Pub. Date: Oct. 29, 2015

(54) CAMPUS SAFETY SYSTEM

(71) Applicant: Worcester Polytechnic Institute, Worcester, MA (US)

(72) Inventors: James A. Beaulieu, JR., Milford, MA (US); Natasha Bonina, Worcester, MA (US); Lauren E. Lewis, Hudson, MA (US); Phyo Thinzar, Manchester, NH (US)

(21) Appl. No.: 14/694,025

(22) Filed: Apr. 23, 2015

Related U.S. Application Data
(60) Provisional application No. 61/983,147, filed on Apr. 23, 2014.

(51) Int. Cl. G08B 25/01

(52) U.S. Cl. CPC G08B 25/016

(57) ABSTRACT

A personal protection device carried or worn by a user has a simple actuator button and transmitter operable within a mesh network covering a monitored environment such as a college campus or industrial park transmits an exigent assistance call to a first responder such as security or DPS (Department of Public Safety) personnel for urgent response. The system for deploying and monitoring the personal protection devices distributes or otherwise transfers possession of an actuator device to a user, such that the actuator device is adapted for wearing or disposing on the user in anticipation of a sudden exigent situation. A distribution repository associates the actuator device with the user, in which the association is temporary for subsequent association with a second user to provide efficient reuse as devices are exchanged or no longer needed.

### RELATED APPLICATIONS

This application claims the benefit under 35 U.S.C. §119(e) of U.S. Provisional Patent Application No. 61/983,147 filed Apr. 23, 2014, entitled “CAMPUS SAFETY SYSTEM” incorporated herein by reference in entirety.

### BACKGROUND

Personal safety becomes particularly concerning to pedestrians when alone, late at night, or in an unfamiliar area. A lone, ambulatory (walking) subject does not have the security of a vehicle or group. Many organizations such as educational and business entities operate in a campus environment, however, where students, employees, and other inhabitants may need to walk between buildings, vehicles and dwellings in the course of normal operations. Often, such a monitored environment employs a specialized security, police, or department of public safety (DPS) group for assisting in maintaining a safe environment. So called “blue light boxes” may be established as beacons from which one can alert the DPS to a need for assistance. However, the blue light boxes occupy fixed locations, and an exigent situation requiring assistance might arise at some distance, causing an inhabitant in distress to run or vocalize a need for assistance and hope that such a call is heeded.

### SUMMARY

A personal protection device carried or worn by a user has a simple actuator button and transmitter operable within a mesh network covering a monitored environment such as a college campus or industrial park transmits an exigent assistance call to a first responder such as security or DPS (Department of Public Safety) personnel for urgent response. The system for deploying and monitoring the personal protection devices distributes or otherwise transfers possession of an actuator device to a user, such that the actuator device is adapted for wearing or disposing on the user in anticipation of a sudden exigent situation. A distribution repository associates the actuator device with the user, in which the association is temporary for subsequent association with a second user to provide efficient reuse as devices are exchanged or no longer needed. In operation, relay nodes, placed similarly to “blue light boxes,” deployed around the monitored environment receive an actuation of the actuation device from a user experiencing an exigent situation, and transmit a wireless signal from the actuator device indicative of the exigent situation. The relay nodes define a mesh network for forwarding the wireless signal to a coordinator node, in which the coordinator node is configured for alerting a first responder of the exigent situation, the identity of the user, and a location of the user, and is typically monitored by first responders for immediate response to an exigent situation.

Configurations herein are based, in part, on the observation that conventional approaches to ambulatory safety rely on fixed stations where a “panic button” may be pressed, or require the user to perform an extended series of actions, such as dialing “911” on a cellphone. Unfortunately, conventional approaches suffer from the shortcoming that a user in an exigent situation, such as direct assault or restraint by an aggressor, may not have time, strength or mental stability to initiate a call for assistance. Accordingly, configurations herein substantially overcome the above described shortcomings by providing a handheld device in immediate proximity to the user with a single actuation for issuing a wireless signal to a local mesh network for alerting first responders such as DPS (Department of Public Safety) or security as to the GPS (Global Positioning System) location of the user.

The disclosed system was created which to signal police/DPS/security to the scene of assistance from which a handheld device may be activated very quickly. It does this by sending GPS coordinates from the handheld to the computer screen of the police dispatcher. This gives police an accurate location to investigate in real time. Additionally, a nearby alarm box (relay node) relaying the signal from the handheld discourages an assailant from persisting. In contrast to conventional approaches, however, users only need possess the handheld when they feel unsafe and want the security in their hand. Otherwise, the handhelds are maintained and stored in on-campus receptacles in various locations. Rather than requiring the user to pay for use of the handhelds, through either an annual fee or one-time cost, the user can borrow a handheld for the duration of any occasion that they feel it necessary. During this time, the handheld is registered to their campus account and they simply return it later the next day, at their convenience. This approach provides users a simple, low overhead security system and provides responders with location data to respond more quickly than if they had to respond to a phone call.

Conventional approaches to hand-held and personal safety devices include a cellphone, which must be dialed using a sequence of keystrokes and usually requires visual based response from screen observation. Other approaches include automobile key fobs, which have a “panic” button to sound the vehicle's horn. No affirmative communication or transmission to a third party is made, however, only the horn sound of the vehicle results. Other devices include medical alert/call devices often marketed as elder care appliances under taglines such as “I've fallen and I can't get up!” These devices are tied only to a single receiver which performs a phone call or IP message transmission. There is no mesh network of multiple receivers or relay nodes defining an area in which the user may occupy and still initiate an assistance call. Further, such devices are dedicated to a single user and cannot be rebranded or associated to another user.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a personal protection device operable in a monitored environment in configurations disclosed herein; and

FIG. 2 is a block diagram for a system in the monitored environment of FIG. 1 suitable for use with configurations herein.

### DETAILED DESCRIPTION

Depicted below is an example deployment scenario using a college campus environment, however any suitable area, region or complex may be protected. The disclosed example depicts a student on a college campus overseen by a campus police organization. The system is comprised of the following parts: a trigger (actuator device), a box (relay node), a coordinator node, and a dispenser, or device repository that retrieves and provides information to a user rental database. The handheld devices including the trigger are operable to inform campus police of the user's location at the press of the button. Since the user simply borrows the device, there would be no maintenance required on the user side. The relay network of boxes would receive the emergency signal from the wireless module of the user's device and transmit it along the shortest route possible to campus police headquarters. In order to have current location data, the handheld device would utilize satellites/GPS data to capture the user's most recent location if the assailant fled from the scene. The information sent along the network would converge at police headquarters through the coordinator. This would be a receiver similar to the boxes and an accompanying program which handles incoming emergency transmissions and does maintenance on the system. Finally, there would need to be a series of units to dispense the handheld devices to users. These dispensing units would be capable of keeping track of the devices rented and maintaining them when they are returned.

To meet the requirements of the system, a number of technologies were integrated in a cooperative and optimal manner. Triggers contain GPS technology, and therefore also contain a low power microcontroller to interpret GPS data coming in as well as all of the data being sent out to the network. The handheld device, the relay boxes, and the coordinator use wireless communication technology to create a network for sending and receiving packets of information. Similarly, information transfer between the dispensing units and the handheld units would be essential to track which student is using which handheld. In order for the handheld units to be maintained by the dispensing units, the dispensers have the ability to charge the handheld. The coordinator would need access to information from the dispensing units as well as the wireless network to present campus police with usable data. In order to allow the relay network to exist both on and off campus, the relay boxes were designed to be entirely wireless and largely independent of the power grid.

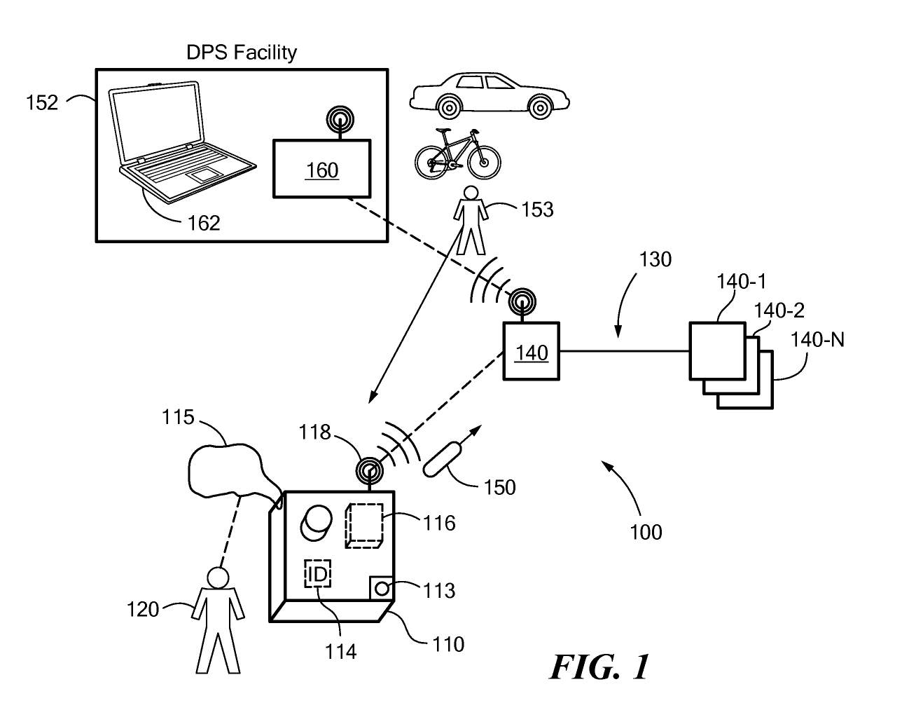

FIG. 1 is a context diagram of a personal protection device operable in a monitored environment in configurations disclosed herein. Referring to FIG. 1, a personal protection device adapted to be carried or worn by a user 120 in the monitored environment 100 in case of personal emergence or other exigent situations such as stalking, assault or robbery includes an actuator device 110 having an actuator 112, such that the actuator 112 is a button or similar switch adapted for unhindered accessibility for requesting assistance in exigent situations. The actuator device 110 includes a registration identifier 114, such as the device ID or a user ID, in which the registration identifier is based on a temporary assignment of the actuator device to the user 120, and is operable for subsequent association with a second user following the temporary assignment, as discussed further below. In the example configuration, the registration identifier is stored in a non-volatile memory on the actuator device 110 for a student ID, employee ID, device ID mappable to (associated with) the student ID, or other identifier indicative of a current user for response and subsequent tracking in the case of a misplaced device.

The actuator device 110 includes transmit and receive (TX/RX) hardware to define an actuator node 116, such that the actuator node 116 has a network interface 118 to a mesh network 130. The network interface 118 is configured to transmit an actuation signal 150 over the network 130 based on the actuator 112, in which the network 130 is coupled to at least one relay node 140-1 . . . 140-N (140 generally). The relay node 140 is configured for receiving the actuator signal 150 indicative of an identity of the user 120 and a location of the user, and forwards the actuator signal 150 to a responsive entity 152 such as security, DPS, or other staffed office for exigent response in the case of a user 120 pressing the actuator 112.

In the example configuration, the actuator 110 has an RF (Radio Frequency) interface coupled to a mesh network 130, and the relay node 140 is defined by a plurality of relay nodes 140-N coupled via the mesh network 130 to a coordinator node 160, such that each relay node 140 is responsive to the actuator signal 150 and operable to transport the actuator signal to the staffed coordinator node 150 at the responsive entity 152 via the mesh network 130. The coordinator node 160 may also be coupled to a console computing device 162 for providing a GUI (Graphical User Interface) responsive to the actuator signal 150 and other administrative functions, discussed further below.

The actuator devices 110 are physically distributable in the monitored environment 100. In some instances, a distribution repository, discussed further below, automates distribution and collection with various users. To deploy an actuator device 110 to a user, a registration interface 113 in the actuator device 110 is invoked. The registration interface is responsive to a change in possession of the actuator device 110 and upon the change in possession, and the actuator device 110 is responsive to an identity of the subsequent user 120′ for associating the subsequent user 120′ with the actuator device 110.

Many monitored environments are generally open to common pedestrian and vehicle traffic, although maintain a concentration or exclusivity of buildings, parking lots and common areas under common ownership and control. Typical examples include college campuses, industrial parks, shopping malls, transportation hubs and other open or semi controlled access areas where some, but not all occupants share a relation to a common entity. People (users) associated with the common entity are often issued an ID card or band that has a personal identifier, or credential, to uniquely identify the student, employee, member, etc. that can be used to associate with a registration identifier.

The actuator device 110 is adapted to receive the registration identifier of the user from an exchange of a unique user credential, as may be encoded on a magnetic strip of an ID card, on an RFID (Radio Frequency ID), or an optically scanned symbol such as a barcode. Therefore, the unique user credential may take the form of at least one of an RFID, magnetic strip or optically scanned symbol, recognized by the registration interface 113.

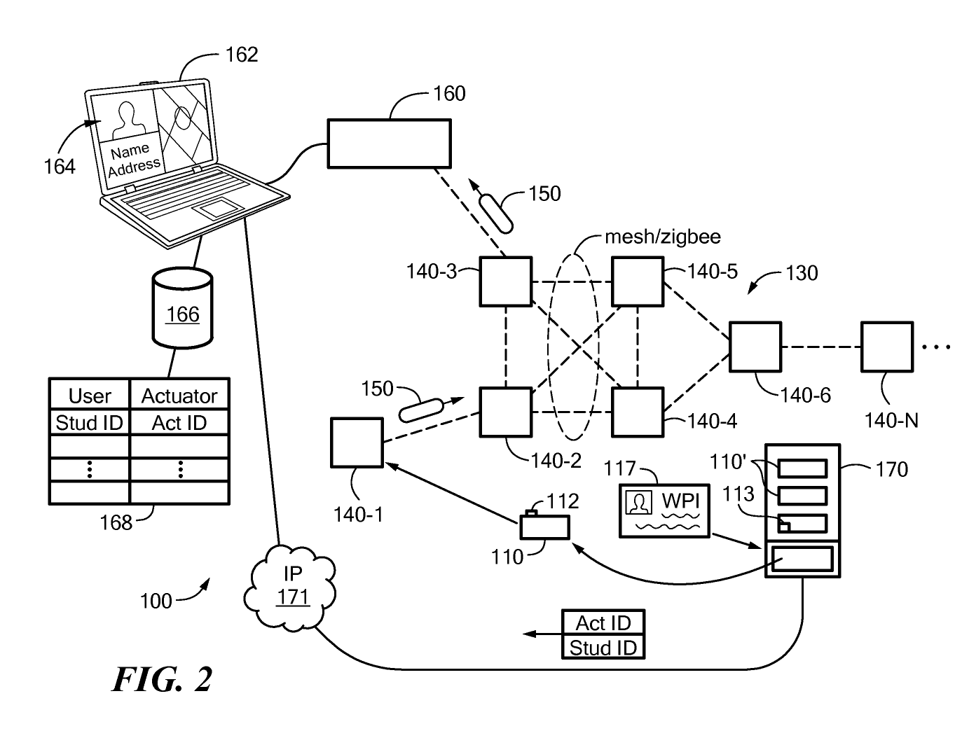

FIG. 2 is a block diagram for a system employing the actuator device for in the monitored environment of FIG. 1. Referring to FIGS. 1 and 2, in the monitored environment 100, the system provides invoking the actuator device 110 as a call device for exigent situation response. The environment 100 includes a plurality of relay nodes 140 defining a mesh network 130 substantially covering the monitored environment 100. Placement of the relay nodes 140 provides for connectivity between the relay nodes 140 and an actuator device 110 anywhere in the monitored environment 100. A plurality of actuator devices 110 carried by users 120 each define an actuator node 116 in the mesh network 130, in which the actuator device 110 has an actuator 112 button or switch and is adapted to be carried or worn by a user, such that the actuator 112 is adapted for unhindered accessibility for requesting assistance in exigent situations. The actuator device 110 may include a lanyard 115, clip or attachment such as a hook-and-loop fastener for maintaining proximity to the user 120 during walking, for example.

A coordinator node 160 couples to the mesh network for receiving the actuator signal 150 over the mesh network 130 based on the actuator on any of the deployed actuator devices 110 of the plurality of actuator devices. Each of the relay nodes 140 is configured for receiving the actuator signal 150 indicative of an identity of the user 120 and a location of the user, and for forwarding the actuator signal 150 to a responsive entity for exigent response. Therefore, each of the actuator nodes 116, relay nodes 140, and coordinator node 160 are nodes within the mesh network 130 and have wireless communication capability with other nodes in the mesh network 130. In the example arrangement, the mesh network is a ZIGBEE® network, and the nodes include transmit and receive (TX/RX) hardware, however alternate mediums may be selected. The coordinator node 160 remains fixed at a monitored location in a security station, DPS facility or other responsive entity to permit real time observance and response by first responders. The relay nodes 140 remain fixed and dispersed throughout the monitored environment for providing effective coverage to an actuator device 110 of a user 120 anywhere in the monitored environment. The actuator device 110 includes hardware for the actuator node 116, as well as the actuator 112, registration interface 113, registration identifier 114 and network interface 118, such as an RF antenna for transmission to the nearest relay node 140.

Distribution of the actuator devices 110 in the monitored environment 100 involves the use of a device repository 170 accessible to a plurality of users 120, such that the device repository 170 is responsive to an identity of the user 120 for transferring possession to the user for temporary association with the user in anticipation of an exigent situation risk. The system verifies user identity prior to dispensing an actuator device 110, and each device repository 170 maintains an available supply of undeployed devices 110′ which are not currently associated with a particular user 120. During each deployment, the system determines the user ID from an exchange of a unique user credential stored on a token of the user, such as a student ID 117, for denoting the user as a member of the monitored environment 100. The registration interface 113 may read the token from the ID 117, or the device repository 170 (dispenser) may read the ID 117. The device repository 170 dispenses the actuator devices 110 to a plurality of users 120 in the monitored environment 110, such that dispensing is performed by an automated exchange of the unique user credential associated with each user at a device repository 170 generally accessible in the monitored environment.

Upon dispensing, which transfers possession of the actuator device 110 to the user 120, associating the actuator device 110 with the user 120 further includes receiving a unique user credential at the device repository 170, such that the device repository 170 maintains possession of the actuator device 110 until authentication. The device repository 170 associates an indication of the identity of the user, such as a student ID 117, with an identifier of the actuation device 110, and transfers possession of the actuator device 110 from the device repository 170 to the user 120 based on the association, such as through a slot in the repository 170.

Association of the user 120 for establishing the registration identifier 114 in the actuator device 110 includes associating a user ID corresponding to the user 120 with an identifier of the actuator device 110. An IP link 171 transports the association via a wired network 172 to a server, such as the console computing device 162, and a DB (Database) 166 stores the association in a server table 168 responsive to the coordinator node 160 for subsequent retrieval in response to the received actuator signal 150. Alternatively, the registration identifier 114 could be satisfied by writing the student ID in the actuator device, but maintaining the same device ID avoids the need for a writable interface in the device 110 while still allowing transfer to subsequent users 120 by updating the association in the server table 168. In an alternate configuration, the actuator device 110 may transmit the registration identifier via the mesh network 130.

To maintain widespread availability throughout the monitored environment 100, distribution repositories or kiosk stations are disposed around the environment 100. The actuator device 110 is adapted to associate a second user 120′ with the actuator device 110 based on the first user relinquishing possession and the actuator device 110 receiving a registration identifier 114 corresponding to the second user 120′. For example, the distribution repository may simply accept the actuator device 110 via a return slot, disassociate the user 120, and await subsequent users for other devices 110. Presumably, each distribution repository would maintain a sufficient stock of available actuator devices 110.

In operation by a distressed user 120, the method of transmitting an exigent assistance call to a first responder includes transferring possession of the actuator device 110 to a user 120 as described above, such that the actuator device 110 is adapted for wearing or disposing on the user in anticipation of a sudden exigent situation. For example, the actuator device 110 may be picked up by a user 120 at a device repository 170 while exiting a building or residence party late at night.

The console 162 associates the newly acquired actuator device 110 with the user 120 as discussed above, such that the association is temporary for subsequent association with a second user, as the user 120 only needs the device to arrive home safely that night, and may return the actuator device 110 to a repository in the morning. However, should an event requiring a distress call occur, the actuation device 110 receives an actuation 112 from a user 120 experiencing an exigent situation. The actuator node 116 in the device 110 transmits a wireless signal from the actuator device 110 indicative of the exigent situation to the nearest relay node 140. This includes transmitting, in response to the received actuation, an actuator signal 150 including an indication of the identity of the user 120 and the location of the user to a relay node 140 in the mesh network 130, in which the mesh network provides coverage of the monitored environment for transport of actuation signals from a plurality of deployed actuation devices 110 to the coordinator node 160.

The mesh network 130 forwards the wireless signal to the coordinator node 160, such that the coordinator node is configured for alerting a first responder 153 of the exigent situation, the identity of the user 120, and a location of the user. The coordinator node 160 receives the actuator signal 150 including an identifier of the actuator device and a location of the user 120, and maps the identifier of the actuator device to the associated user 110 using the server table 168 and associated console 162. The console 162 invokes a location service to determine a current position of the user in the monitored environment; and an associated GUI 164 renders the identity of the user 110 and the current position within the monitored environment to a first responder 153 for rapid response.

The GUI 164 allows the first responders to visualize an image of the user 120 and personal information such as address and personal characteristics as on a student ID or driver's license, and also displays a geographic street map showing a GPS location of the user 110 in the locale. Invokable GPS cognizant services such as GOOGLE® Maps and GOOGLE® Earth may be invoked to perform such street level mapping. This allows first responders 153 to quickly move to render assistance at the user location. GPS coordinates are updated, if the user moves, and the relay node 140 receiving the actuator signal 150 may also sound an audible alarm to further facilitate user location.

Upon the temporary usage by a user, the actuator device 110 may be redeployed in conjunction with a second user 110′ upon relinquishing of possession of the first user and exchange of a unique user credential corresponding to the second user. Upon return of the actuator device 110 to a device repository 170, the system associates a second user 140′with the actuator device based on the first user relinquishing possession and the actuator receiving a registration identifier 114 corresponding to the second user.

In the example campus environment depicted, other features disclosed include the following. A particular feature allows the dispenser to read an individual trigger's ID when a student or other member of the monitored environment attempted to dispense it. When this trigger's ID was read, the dispensing unit would then need the capability to associate the student ID and trigger ID in a database. That way, when an emergency signal was sent via the ZigBee module, the unique identification of the trigger that the module provides would allow the campus police to then determine which student was in trouble. Providing identifying information such as a name and picture in addition to location data would allow the first responders to the scene to quickly find the potential victim and come to assist.

The example mesh network incorporates a ZigBee based approach. Zigbee is may not be as fast as Wi-Fi, since the data rate is usually 250 KB/s in comparison to the data rate for Wi-Fi which is about 54 Mb/s. For the disclosed approach, however, the data being sent between the Trigger and each Box is small enough so that 250 KB/s is more than enough speed. Another advantage of ZigBee is that it can support thousands of nodes in a single network. A Zigbee network can be configured in a point-to-point network or in a mesh network. In a point-to-point network, all of the nodes are able to communicate with each other, and send data to each node. The other network that ZigBee modules can be configured as is a mesh network. A mesh network uses a different approach to sending data throughout the network. In each mesh network, there is one coordinator that maintains the network by managing the associated devices and routes. Routers send data between nodes that cannot communicate directly due to distance. Endpoints are the last part of the network, which are connected to controllers and sensors. In the example campus environment, there would be one coordinator in the network, which is located as the coordinator at police headquarters. Routers would be used in the Boxes, and Triggers would be endpoints.

Various configurations of GPS capability may be employed. GPS provides a convenient and inexpensive solution to track location. Receivers get information from the GPS satellites orbiting around the earth and use triangulation to calculate the user's location. The information from the satellites gives three-dimensional data—longitude, latitude and altitude. There are different types of GPS receivers available. The standalone systems may not integrate well with the disclosed approach. However GPS modules, which can be embedded into a device, are more configurable with the disclosed approach. The output of the module is a string of ASCII characters which can be converted into longitude, latitude and altitude data by using the NMEA protocol, a standard protocol for GPS systems. The GPS modules are small in size, have an update rate of about 5 to 10 Hz, have average power requirement of 30 mA at 3.3 V, and an accuracy of up to 3 m depending the number of channels of the GPS module. Besides these specifications, there is also a wide availability of software to convert GPS data into maps such as those used for Google Maps or Google Earth For example, software libraries can convert the GPS data into a readable format that gives longitude and latitude information. The GPS data files can then be imported into this program and mapped into Google Maps. Based on this information, we decided to include a GPS module into the trigger because the trigger needs to provide accurate location data, have reasonable power consumption and update rate, and software to easily recover the GPS data into the server.

As is typical with electronic devices not tethered to a wall for main power, the trigger and box need batteries to store energy. Research into what batteries would be suitable for these devices began with a few requirements, namely size, capacity, and nominal voltage. Given that both of these devices have specific charging methods, the batteries would also need to be rechargeable and ease of charging was most desirable. A few types of rechargeable batteries with various chemistries were considered, specifically NiCd, NiMH, NiZn and Li-ion. Present configurations conclude that the best balance of desirable traits would be NiMH, which are the least expensive and most readily available, and they can easily be trickle charged. Additionally, capacity is excellent, and they perform well under high drain conditions. This allows them to last long enough for users to have overnight between charges and easily switch into emergency mode without depleting the battery quickly.

Those skilled in the art should readily appreciate that the programs and methods as defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A personal protection device, comprising:
an actuator device having an actuator and adapted to be carried or worn by a user, the actuator adapted for unhindered accessibility for requesting assistance in exigent situations;
a registration identifier in the actuator device, the registration identifier based on a temporary assignment of the actuator device to the user, the registration identifier operable for subsequent association with a second user following the temporary assignment; and
an actuator node responsive to the actuator disposed on the actuator device, the actuator node having a network interface;
the network interface configured to transmit an actuation signal over a network based on the actuator, the network coupled to at least one relay node, the relay node configured for receiving the actuator signal indicative of an identity of the user and a location of the user, and forwarding the actuator signal to a responsive entity for exigent response.

2. The device of claim 1 wherein the actuator has an RF interface coupled to a mesh network, the relay node further comprising a plurality of relay nodes coupled via the mesh network to a coordinator node, each relay node responsive to the actuator signal.

3. The device of claim 2 wherein the actuator device is adapted to associate a second user with the actuator device based on the first user relinquishing possession and the actuator receiving a registration identifier corresponding to the second user.

4. The device of claim 1 further comprising a registration interface in the actuator device, the registration interface responsive to a change in possession of the actuator device and upon the change in possession, responsive to an identity of the user for associating the user with the actuator device.

5. The device of claim 4 wherein the actuator device is adapted to receive the registration identifier of the user from an exchange of a unique user credential.

6. The device of claim 5 wherein the unique user credential is at least one of an RFID (Radio Frequency ID), magnetic strip or optically scanned symbol.

7. The device of claim 4 wherein the registration interface further comprises a device repository accessible to a plurality of users, the device repository responsive to an identity of the user for transferring possession to the user for temporary association with the user in anticipation of an exigent situation risk.

8. In a monitored environment, a method of transmitting an exigent assistance call to a first responder, comprising:
transferring possession of an actuator device to a user, the actuator device adapted for wearing or disposing on the user in anticipation of a sudden exigent situation;
associating the actuator device with the user, the association being temporary for subsequent association with a second user;
receiving an actuation of the actuation device from a user experiencing an exigent situation;
transmitting a wireless signal from the actuator device indicative of the exigent situation;
forwarding the wireless signal to a coordinator node, the coordinator node configured for alerting a first responder of the exigent situation, the identity of the user, and a location of the user.

9. The method of claim 8 further comprising transmitting, in response to the received actuation, an actuator signal including an indication of the identity of the user and the location of the user to a relay node in a mesh network, the mesh network providing coverage of the monitored environment for transport of actuation signals from a plurality of deployed actuation devices to the coordinator node.

10. The method of claim 9 further comprising
receiving the actuator signal including an identifier of the actuator device and a location of the user;
mapping the identifier of the actuator device to the associated user;
invoking a location service to determine a current position of the user in the monitored environment; and
rendering the identity of the user and the current position within the monitored environment to a first responder.

11. The method of claim 8 wherein associating the actuator device with the user further comprises:
receiving a unique user credential at a device repository, the device repository maintaining possession of the actuator device;
associating an indication of the identity of the user with an identifier of the actuation device; and
transferring possession of the actuator device from the device repository to the user based on the association.

12. The method of claim 11 further comprising associating a second user with the actuator device based on the first user relinquishing possession and the actuator receiving a registration identifier corresponding to the second user.

13. The method of claim 8 further comprising
associating a user ID corresponding to the user with an identifier of the actuator device,
transporting the association via a wired network to a server, and
storing the association in a server table responsive to the coordinator node for subsequent retrieval in response to the received actuator signal.

14. The method of claim 13 further comprising:
determining the user ID from an exchange of a unique user credential stored on a token of the user for denoting the user as a member of the monitored environment.

15. The method of claim 14 further comprising dispensing the actuator devices to a plurality of users in the monitored environment, dispensing performed by an automated exchange of the unique user credential associated with each user at a device repository generally accessible in the monitored environment.

16. A system for providing a call device for exigent situation response, comprising:
a plurality of relay nodes defining a mesh network substantially covering a monitored environment;
a plurality of actuator devices defining an actuator node in the mesh network, the actuator device having an actuator and adapted to be carried or worn by a user, the actuator adapted for unhindered accessibility for requesting assistance in exigent situations;
a coordinator node coupled to the mesh network for receiving an actuator signal over the mesh network based on the actuator on an actuator device of the plurality of actuator devices, the relay node configured for receiving the actuator signal indicative of an identity of the user and a location of the user, and forwarding the actuator signal to a responsive entity for exigent response.

17. The system of claim 16 wherein the coordinator node is operable to redeploy the actuator device in conjunction with a second user upon relinquishing of possession of the first user and exchange of a unique user credential corresponding to the second user.

18. The system of claim 17 wherein the actuator device has an RF interface coupled to a mesh network, the relay node further comprising a plurality of relay nodes coupled via the mesh network to a coordinator node, each relay node responsive to the actuator signal.

19. The system of claim 18 further comprising a registration interface in the actuator device, the registration interface responsive to a change in possession of the actuator device and upon the change in possession, responsive to an identity of the user for associating the user with the actuator device.

20. The system of claim 19 wherein the registration interface further comprises a device repository accessible to a plurality of users, the device repository responsive to an identity of the user for transferring possession to the user for temporary association with the user in anticipation of an exigent situation risk.
